(19) United States
(12) Patent Application Publication
(10) Pub. No.: US 2026/0111166 A1
(43) Pub. Date: Apr. 23, 2026

(54) BOOST OPERATION FOR BATTERY-POWERED PLAYBACK DEVICES

(71) Applicant: Sonos, Inc., Goleta, CA (US)

(72) Inventors: Sean Simon, Boston, MA (US); Joern Riemer, Boston, MA (US)

(21) Appl. No.: 19/148,962

(22) PCT Filed: Feb. 8, 2024
(86) PCT No.: PCT/US2024/014993

§ 371 Date: Jul. 17, 2025

Related U.S. Application Data
(60) Provisional application No. 63/484,223, filed on Feb. 10, 2023.

(51) Int. Cl. G06F 3/16; H02J 7/82; H04R 3/00; H04R 29/00

(52) U.S. Cl. CPC G06F 3/165; H02J 7/82; H04R 3/00; H04R 29/001

(57) ABSTRACT

Embodiments disclosed herein include playback devices with power circuitry configured to provide extended playback time by employing a battery boost mode of operation. In some embodiments, boost mode is employed when the battery state of charge (SoC) falls below a first threshold value that is normally associated with battery depletion, and the playback device is subsequently plugged in for charging. Boost mode allows the device to continue operating and providing audio playback for the user for an extended period of time, until the battery SoC falls below a second, lower threshold value. At that point playback ceases and the device is powered down to allow the battery to charge. The device remains powered down until charging raises the SoC to a point that allows operation. Boost mode, however, remains disabled until the SoC rises still further to a third threshold value that is closer to a full SoC.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIG. 1I illustrates an example communication system that includes example switching circuitry and/or communication circuitry configurations.

FIG. 2 is a block diagram of an example power system of a playback device.

FIG. 3 illustrates an example user interface of a playback device.

FIG. 4 illustrates boost mode operation of a playback device as a function of battery state of charge over time.

FIG. 5 is a boost mode state diagram of a playback device.

FIG. 6 shows an example embodiment of a method for a playback device to implement boost mode operation, in accordance with aspects of the disclosed technology.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

SONOS, Inc. has a long history of innovating in the wireless audio space as demonstrated by the successful launch of numerous wireless audio products including battery operated portable playback devices, such as SONOS ROAM and SONOS MOVE. Building upon years of experience creating sophisticated, yet easy-to-use, audio products, SONOS, Inc. has appreciated the importance of providing a high quality user experience. For battery operated playback devices, one way to improve the user experience is to increase the available play time before the device shuts down due to battery depletion. One technique to provide additional play time is to employ a battery boost mode of operation which allows the battery to continue providing energy, even after the state of charge falls below a threshold value at which the device would ordinarily shut down (e.g., an empty state). This boost mode can be activated when the user signals a desire to continue operating the playback device, for example by plugging the device into a charger shortly before or after the battery reaches the empty state. Boost mode allows the playback device to continue operating, after the charge state falls below the normal minimum operating level, by tapping into a remaining energy reserve of the battery in conjunction with energy provided by the battery charging circuit. The additional play time provided by boost mode operation can provide a meaningful improvement to the user experience by providing an energy reserve when it is most needed.

Accordingly, aspects of the present disclosure relate to techniques for boost mode battery operation to provide extended play time. In some instances, boost mode may be activated in response to a determination of the user's intent to continue playback after the battery has discharged to a nominally empty condition (e.g., a first threshold value). Although this condition is typically referred to as an empty state, batteries generally have additional remaining reserve that can be utilized, although doing so too often can be damaging to the battery. Operation in boost mode may then continue until the battery has further discharged to a level (e.g., a second threshold value) beyond which the remaining reserve is exhausted, and playback is no longer possible. At that point further charging is needed to replenish the battery to a higher state of charge, and preferably to a full charge state. Repeated boost mode operation, in which the battery reserve is drawn upon, can be harmful to the battery over the long term. For this reason, future boost mode operation is disabled after the battery falls below the second threshold value and is not reenabled until the battery is more fully recharged, for example to a third threshold that is closer to a full state of charge to prevent the user from operating the device in a continual boost mode.

To this end, embodiments disclosed herein describe playback devices that include a power system configured to enable battery boost mode operation. The power system includes a battery fuel gauge, a power management circuit, and a charger circuit. The battery fuel gauge is configured to measure the state of charge of the battery. The power management circuit, under control of a processor, is configured to implement boost mode operation based on measurements of the battery state of charge provided by the fuel gauge and on charging status provided by the charger circuit, as will be described in greater detail below.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

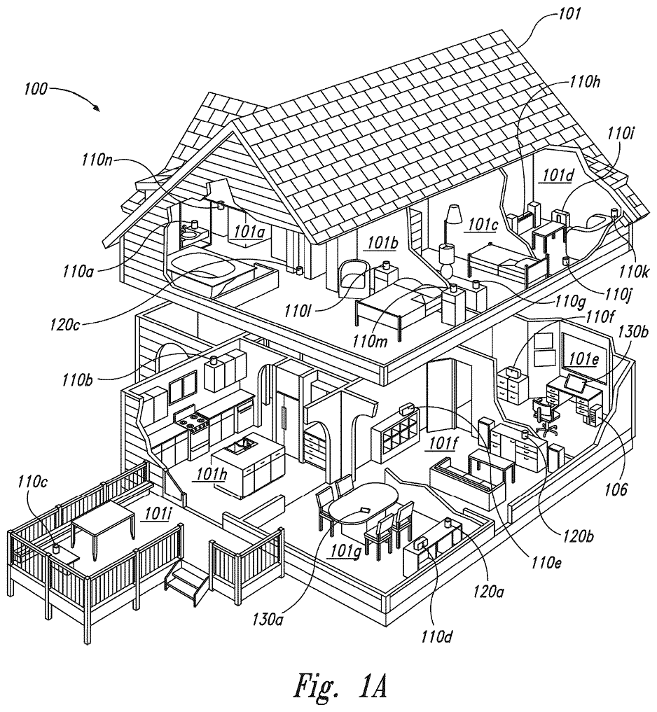

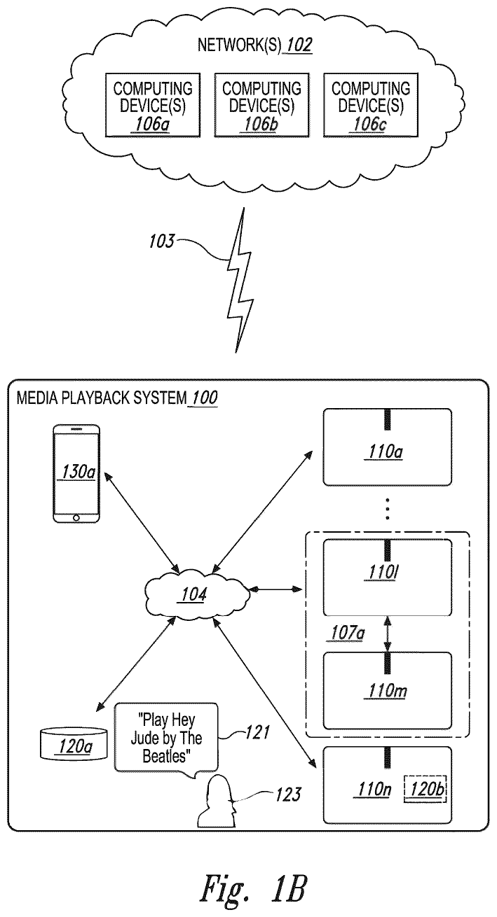

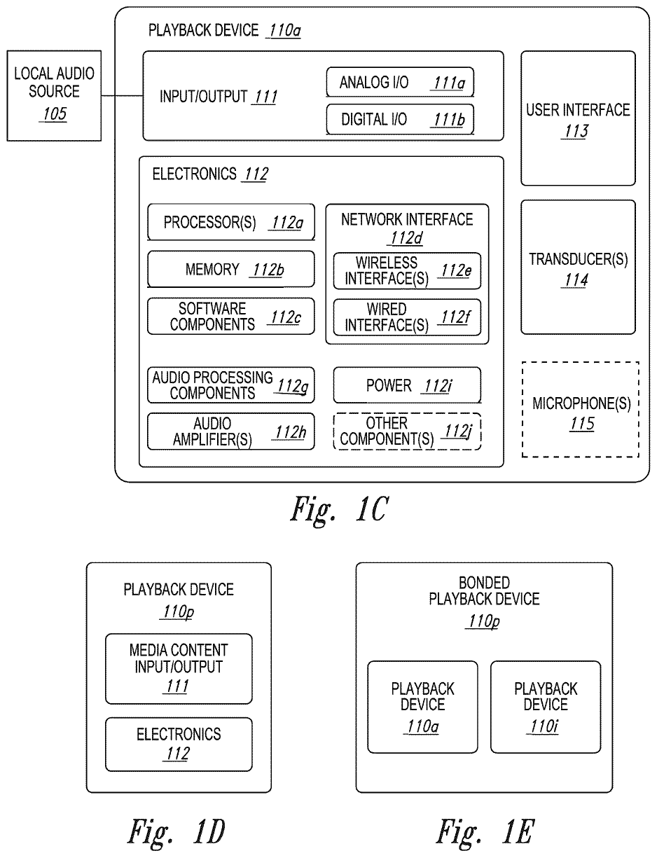

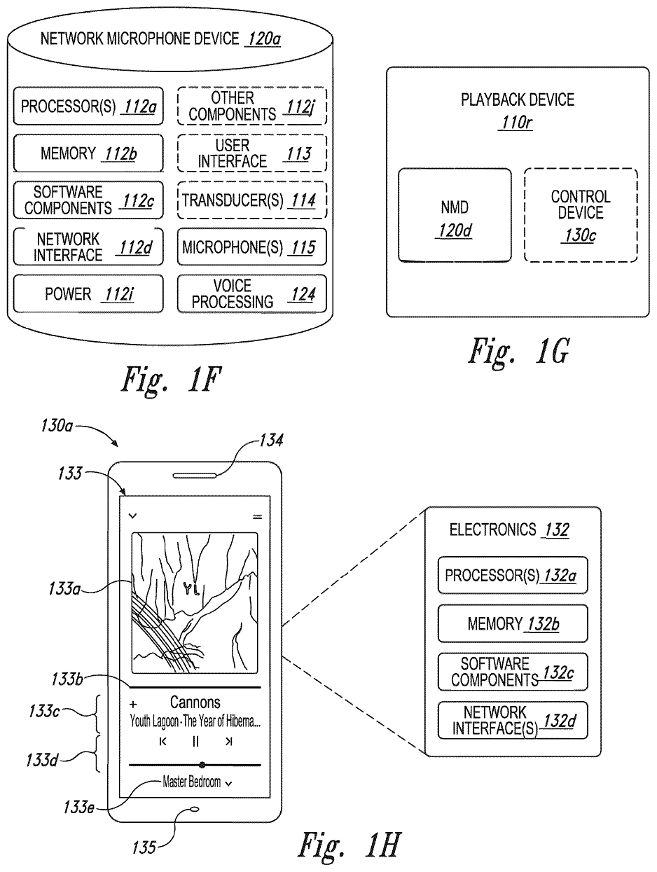

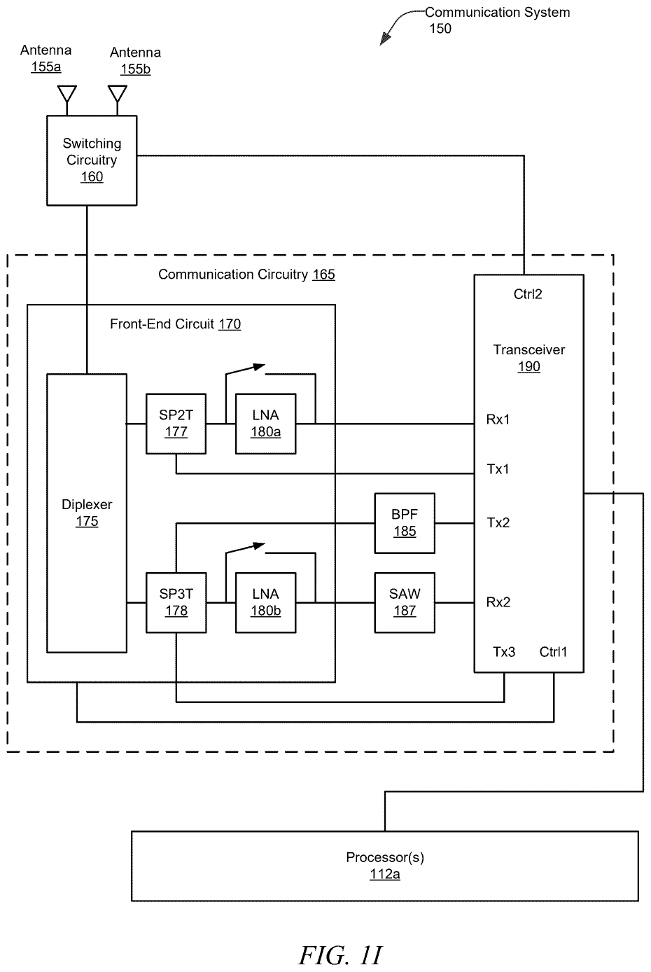

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles, and other features shown in the Figures are merely illustrative of particular embodiments of the disclosed technology. Accordingly, other embodiments can have other details, dimensions, angles, and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices, etc.) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation, etc.). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1H.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane, etc.), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 1101 and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication networks, and/or other suitable data transmission protocol networks), etc. The cloud network 102 is configured to deliver media content (e.g., audio content, video content, photographs, social media content, etc.) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household or commercial facility communication network (e.g., a household or commercial facility WiFi network). In some embodiments, the links 103 and the network 104 comprise one or more of the same networks. In some aspects, for example, the links 103 and the network 104 comprise a telecommunication network (e.g., an LTE network, a 5G network, etc.). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud servers that host cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length, etc.) and other associated information (e.g., URIs, URLs, etc.) for each identifiable media item found. In some embodiments, for example, the media content database is stored on one or more of the playback devices 110, network microphone devices 120, and/or control devices 130.

In the illustrated embodiment of FIG. 1B, the playback devices 1101 and 110m comprise a group 107a. The playback devices 1101 and 110m can be positioned in different rooms and be grouped together in the group 107a on a temporary or permanent basis based on user input received at the control device 130a and/or another control device 130 in the media playback system 100. When arranged in the group 107a, the playback devices 1101 and 110m can be configured to play back the same or similar audio content in synchrony from one or more audio content sources. In certain embodiments, for example, the group 107a comprises a bonded zone in which the playback devices 1101 and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS®, AMAZON®, GOOGLE® APPLE®, MICROSOFT®, etc.). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises an High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication link. In certain embodiments, the analog I/O 111a and the digital 111b comprise interfaces (e.g., ports, plugs, jacks, etc.) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer, etc.) or another suitable audio component (e.g., a television, a desktop computer, an amplifier, a phonograph, a Blu-ray player, a memory storing digital media files, etc.). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens, etc.), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B)), amplify the received audio, and output the amplified audio for playback via one or more of the transducers 114.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over-Ethernet (POE) interfaces, and/or other suitable sources of electric power). In some embodiments, the electronics 112 optionally include one or more other components 112j (e.g., one or more sensors, video displays, touchscreens, battery charging bases, etc.).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone, etc.).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds, etc.) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receive and process the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE, etc.). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 exclude the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DACs), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omit the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers 112h include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G amplifiers, class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 include a single one of the amplifiers 112h configured to output amplified audio signals to a plurality of the transducers 114. In some other embodiments, the electronics 112 omit the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” and “SUB.” Other suitable playback devices may additionally or alternatively be used to implement the playback devices of example embodiments disclosed herein. Additionally, one of ordinary skill in the art will appreciate that a playback device is not limited to the examples described herein or to SONOS product offerings. In some embodiments, for example, one or more playback devices 110 comprise wired or wireless headphones (e.g., over-the-ear headphones, on-ear headphones, in-ear earphones, etc.). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is a full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers, etc.).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input, etc.) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyze the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing components 124 monitor the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone“, an Android phone, etc.) on which media playback system controller application software is installed. In some embodiments, the control device 130a comprises, for example, a tablet (e.g., an iPad”), a computer (e.g., a laptop computer, a desktop computer, etc.), and/or another suitable device (e.g., a television, an automobile audio head unit, an IoT device, etc.). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE, etc.). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection, etc.) from the control device 304 to one or more of the playback devices 100. The network interface 132d can also transmit and/or receive configuration changes such as, for example, adding/removing one or more playback devices 100 to/from a zone, adding/removing one or more zones to/from a zone group, forming a bonded or consolidated player, separating one or more playback devices from a bonded or consolidated player, among others.

The user interface 133 is configured to receive user input and can facilitate control of the media playback system 100. The user interface 133 includes media content art 133a (e.g., album art, lyrics, videos, etc.), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year, etc.) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone, etc.). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound, etc.) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device, etc.) comprising a portion of the electronics 132 and the user interface 133 (e.g., a touch screen) without any speakers or microphones.

### III. Example Communication Systems

FIG. 1I, shows an example communication system 150 that includes example switching circuitry 160 and/or communication circuitry 165 configurations. The communication system 150 may be implemented in, for example, any of a variety of network devices including the playback devices 110. For example, the communication system may be used to communicate with other playback devices or components of a home theater system. Such communication may include instructions, control signals, or messages of any type.

Referring to FIG. 1I, in some embodiments, the communication circuitry 165 is coupled to a common port of the switching circuitry 160 and comprises a front-end circuit 170, a filter 187, a transceiver 190, and a filter 185. Optionally, in some embodiments, the filter 187 and/or the filter 185 may be included in the front-end circuit 170. Further, in some embodiments, the transceiver 190 may be coupled to the one or more processors 112a. The transceiver 190 may be configured for operation in multiple modes (e.g., a UWB mode, a 2.4 GHz WI-FI operation mode, a 5.0 GHz WI-FI operation mode, a 6.0 GHz WI-FI operation mode, and/or a BLUETOOTH operation mode).

In some embodiments, the switching circuitry 160 may be configured to selectively couple one of antennas 155a and 155b to the communication circuitry 165 based on a received control signal. The switching circuitry 160 may be implemented using, for example, one or more switches such as a single-pole, double throw switch (SP2T) switch. In some examples, the control signal may be generated by, for example, the transceiver 190 (e.g., provided via a second control port (CTRL2)). In these examples, the transceiver 190 may comprise one or more network processors that execute instructions stored in a memory (e.g., a memory within the transceiver 190 such as an internal read-only memory (ROM) or an internal read-write memory) that causes the transceiver 190 to perform various operations. An antenna switching program (e.g., that controls the switching circuitry 160 in accordance with the methods described herein) may be stored in the memory and executed by the one or more network processors to cause the transceiver 190 to generate and provide control signals to the switching circuitry 160. In other examples, the control signal for the switching circuitry 160 may be generated by the processor 112a instead of the transceiver 190.

In some embodiments, the front-end circuit 170 may further include a diplexer 175 comprising (i) a first port coupled to a SP2T switch 177, (ii) a second port coupled to a single pole, triple throw (SP3T) switch 178, and (iii) a third port coupled to the switching circuitry 160. The diplexer 175 is configured to separate multiple channels, for example, using one or more filters. More specifically, the diplexer 175 receives a wide-band input from one or more of the antennas 155a and 155b (e.g., via the switching circuitry 160) and provides multiple narrowband outputs. For example, the diplexer 175 may provide a first narrow-band output for a 5 GHz frequency band at the first port to SP2T switch 177 and provide a second narrow-band output for a 2.4 GHz frequency band at the second port to SP3T switch 178.

In some embodiments, SP2T switch 177 comprises a first port coupled to a low noise amplifier (LNA) 180a, a second port coupled to a first transmit port (TX1) of the transceiver 190 (e.g., a 5.0 GHz WI-FI transmit port), and a common port coupled to the diplexer 175. The SP2T switch 177 is configured to selectively couple the common port of the SP2T switch 177 to either the first port or the second port of the SP2T switch 177 based on a received control signal. The control signal may be provided by, for example, the transceiver 190 (e.g., via a first control port (CTRL1) of the transceiver 190).

In some embodiments, SP3T switch 178 comprises a first port coupled to LNA 180b, a second port coupled via BPF 185 to a second transmit port (TX2) of the transceiver 190 (e.g., a 2.4 GHz WI-FI transmit port), a third port coupled to a third transmit port (TX3) of the transceiver 190 (e.g., a BLUETOOTH transmit port), and a common port coupled to the diplexer 175. The SP3T switch 178 is configured to selectively couple the common port of the SP3T switch 178 to either the first port, the second port, or the third port of the SP3T switch 178 based on a received control signal. The control signal may be provided by, for example, the transceiver 190 (e.g., via the first control port (CTRL1) of the transceiver 190).

In some embodiments, each of the LNAs 180a and 180b are further coupled to a first receive port (RX1) (e.g., a 5.0 GHz WI-FI receive port) and a second receive port (RX2) (e.g., a 2.4 GHz WI-FI and/or BLUETOOTH receive port) via filter 187, respectively, of the transceiver 190. In operation, the LNAs 180a and 180b amplify the wireless signals detected by the antennas prior to being received by the transceiver 190 (which may contain additional amplifiers such as additional LNAs) to improve receive sensitivity of the communication system 150. A bypass switch may be coupled in parallel with each of the LNAs 180a and 180b that may be controlled by the transceiver 190 (e.g., via the first control port CTRL1 of the transceiver 190). In operation, the bypass-switch allows the transceiver 190 (or other control circuitry) to close the bypass-switch when the signal received at the transceiver 190 is above a threshold to avoid saturation of one or more amplifiers in the transceiver 190. Thus, the bypass-switch may be open when the signal received at the transceiver 190 has an amplitude below a threshold to improve receive sensitivity and closed when the signal received at the transceiver 190 has an amplitude above the threshold to avoid amplifier saturation.

The filter 187 is desirable in some embodiments to filter out external noise from the environment. In a standard operating environment, there may be a lot of noise near and in the 2.4 GHz band including, for example, noise from cordless home phones, cell phones, etc. In operation, the filter 187 is configured to remove such wireless signal interference in the operating environment. The filter 187 may be designed as a bandpass (BPF) filter, a low-pass filter, and/or a high-pass filter.

The filter 185 may be desirable in some embodiments to reduce out-of-band energy in the output from the transceiver 190 (e.g., from the second transmit port TX2). For example, the output of the transceiver 190 may comprise some energy that is out-of-band when outputting a wireless signal in a channel that is on the edge of the band (e.g., channel 1 or channel 11 in a 2.4 GHz Wi-Fi band). The filter 185 may be designed as a BPF filter, a low-pass filter, and/or a high-pass filter. The filter 185 may, in some implementations, be implemented as a controllable filter (e.g., a controllable BPF). For example, the filter 185 may comprise a BPF and one or more switches that either allow the BPF to be incorporated into the signal path between the transceiver 190 and the SP3T switch 178 or bypassed. In this example, the transceiver 190 may provide a control signal (not shown) to the controllable filter to either have the BPF be included in the signal path or bypassed.

The filters 185 and 187 may be constructed in any of a variety of ways. For instance, the filters 185 and 187 may be constructed using one or more of: a surface acoustic wave (SAW) filter, a crystal filter (e.g., quartz crystal filters), and/or a bulk acoustic wave (BAW) filter. Further, the filter 185 need not be constructed in the same way as the filter 187. For instance, the filter 187 may be implemented as a SAW and the filter 185 may be implemented as another type of filter.

It should be appreciated that the communication system 150 shown in FIG. 1I may be modified in any of a variety of ways without departing from the scope of the present disclosure. For example, the number of one or more components (e.g., antennas, filters, front-end circuits, etc.) may be modified based on the particular implementation. For instance, as shown in FIG. 1I, the number of antennas may be reduced to 1 (shown as antenna 155a) and, as a result of reducing the number of antennas, the switching circuitry 160 may be removed altogether.

Further, in some embodiments, the wireless transceiver 190 may be implemented as a Multi-Input and Multi-Output (MIMO) transceiver (e.g., a 2×2 MIMO transceiver, 3×3 MIMO transceiver, 4×4 MIMO transceiver, etc.) instead of a Single-Input-Single-Output (SISO) transceiver as shown in Figure II. In such an implementation, the front-end circuit 170 may be duplicated for each additional concurrently supported transmit and/or receive signal chain supported by the MIMO transceiver. For instance, the communication circuitry 165 may comprise three front-end circuits 170 for a 3×3 MIMO wireless transceiver (one front-end circuit 170 for each supported transmit and/or receive signal chain). Further, in such MIMO transceiver implementations, the switching circuitry 160 may be removed in some cases. For instance, the switching circuitry 160 may be removed in cases where the number of antennas is equal to the number of supported concurrent transmit and/or receive signal chains (e.g., the switching circuitry 160 may be removed when using two antennas with a 2×2 MIMO transceiver). In other cases, the switching circuitry 160 may still be employed. For example, the communication system 150 may comprise six antennas and a 2×2 MIMO transceiver. In this example, the communication system 150 may still employ switching circuitry 160 to down select from the six antennas to the two antennas that may be coupled to the 2×2 MIMO transceiver at a given time.

### IV. Example Systems and Devices

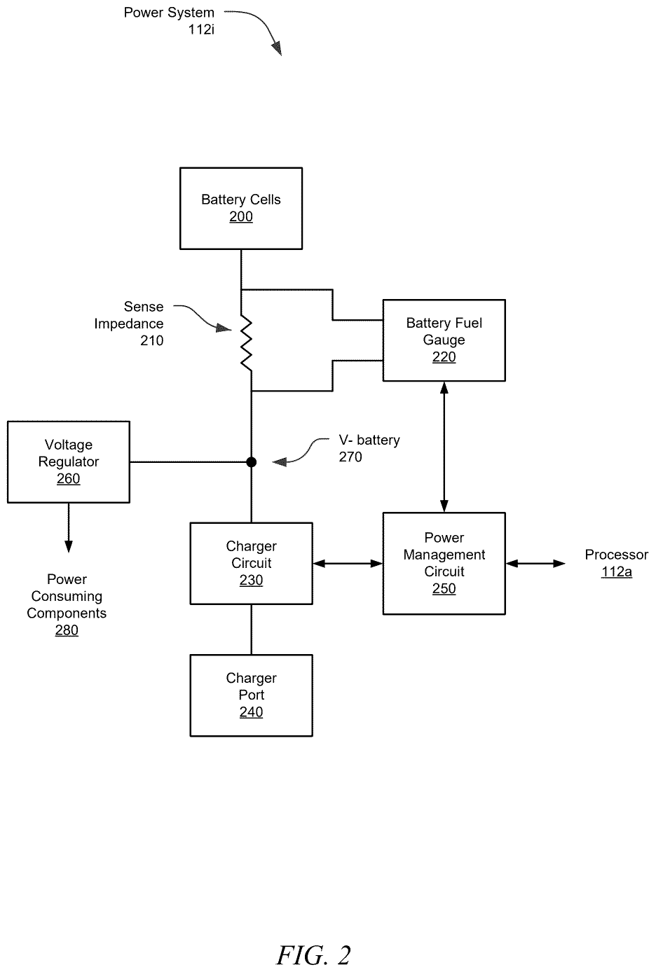

As discussed above, battery powered portable playback devices may comprise a power system configured to implement a battery boost mode of operation. For instance, FIG. 2 illustrates a block diagram of an example power system 112i of a playback device. The power system of this example is shown to include battery cells 200, a sense impedance 210, a battery fuel gauge 220, a voltage regulator 260, a power management circuit 250, a charger circuit 230, and a charger port 240.

The battery cells (or simply battery) 200 are configured to provide energy to the playback device. The state of charge of the battery can range from fully charged to empty. The battery voltage, V-battery 270, ranges from a relatively high value, associated with the fully charged state, down to a lower value, associated with the empty state. The fully charged state is generally reached after the battery has been charged to an upper charge limit that the battery is capable of achieving. The charge state then decreases as the playback device is operated, for example by playing audio, wirelessly communicating over a network, interacting with a user through the user interface, etc. Eventually the charge state will decrease to the empty state, at which point the device would ordinarily shut down. Although operation of the playback device while the battery charge state is in a range between fully charged and empty is considered normal, the battery cells 200 generally have a remaining energy capacity that can be drawn upon for operation below the empty state. In some embodiments, this additional energy reserve can be used, in part, for boost mode operation to provide additional play time to improve the user experience, until the battery charge state further decreases to a depleted state at which point operation is no longer possible (e.g., the reserve capacity has been exhausted). Repeated drawdown of this additional energy reserve, however, can be damaging to the battery cells over long term use, so, in some embodiments, limits may be placed on boost mode operation.

The battery fuel gauge 220 (also referred to as a power monitor) is configured to measure the charge state of the battery cells, which can also be used to provide an indication of remaining available play time. In some embodiments, the battery fuel gauge 220 operates by measuring the voltage drop across sense impedance 210. In some embodiments, sense impedance 210 may be implemented as a resistor of relatively low impedance to avoid excessive power consumption. The voltage drop across sense impedance 210 is proportional to the current flowing to or from the battery, which in turn is related to the charge state of the battery. The relationship between the voltage drop (or equivalently current flow) and the battery charge state is not necessarily linear, but can be determined through calibration, experimentation, modelling, or any other suitable method. In some embodiments, the battery fuel gauge may determine the charge state based on the voltage drop and provide the charge state to the power management circuit 250. In some other embodiments, the battery fuel gauge may simply provide the voltage drop to the power management circuit 250 and the determination of charge state may be calculated by the power management circuit.

In some embodiments, the battery cells 200 are implemented as a “smart battery,” in which case the sense impedance 210 and battery fuel gauge 220 are integrated into the smart battery.

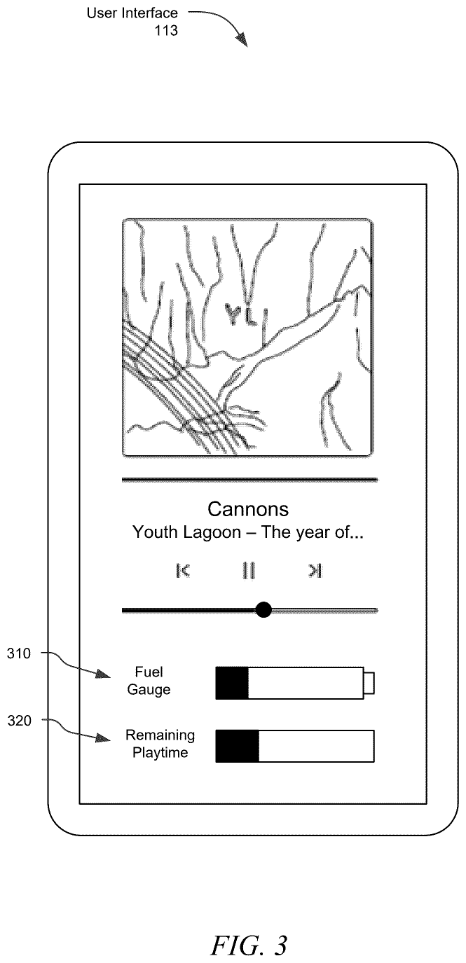

In some embodiments, the charge state of the battery may be displayed on the user interface 113 of the playback device, for example as “Fuel Gauge” 310, as illustrated in FIG. 3. In some embodiments, the remaining available play time may also be displayed, for example as “Remaining Playtime” 320, also illustrated in FIG. 3. In some embodiments, the remaining available play time may be derived from the battery charge state and a known value for the maximum playtime of the device. For example, if the device has a known maximum playback time of 50 hours and the charge state is 20 percent, then the remaining playtime may be estimated as 10 hours (e.g., 20 percent of 50 hours).

The voltage regulator 260 is configured to convert the battery voltage 270 to one or more voltages that are suitable for energizing the power consuming components 280 of the playback device, such as the amplifier, wireless radio, processor, etc. The voltage regulator 260 is configured handle battery voltages that vary over a range of values that are associated with battery charge states extending from the full state down to the empty state, and further down to the depleted state at which boost mode operation ceases.

The charger circuit 230 is configured to provide a charging current to the battery 200, under control of the power management circuit 250, when the charger port 240 is plugged into a power source. In some embodiments, the charger port 240 may be a USB port that provides DC charging current. In some embodiments, the power system may include multiple charger circuits, for example a first charger circuit for a USB port providing DC current and a second charger circuit for a wireless power receiver providing AC current. The power management circuit can coordinate usage of the multiple charger circuits so that only one is use at a time.

The power management circuit 250 is configured to control the battery fuel gauge 220 and the charger circuit 230 and to implement, in conjunction with processor 112a, the battery boost mode operation, as described below.

As previously noted, FIG. 3 illustrates an example user interface 113 of a playback device that includes a fuel gauge 310 and/or a remaining playtime indicator 320 in addition to various other controls, displays, and indicators associated with playback operations.

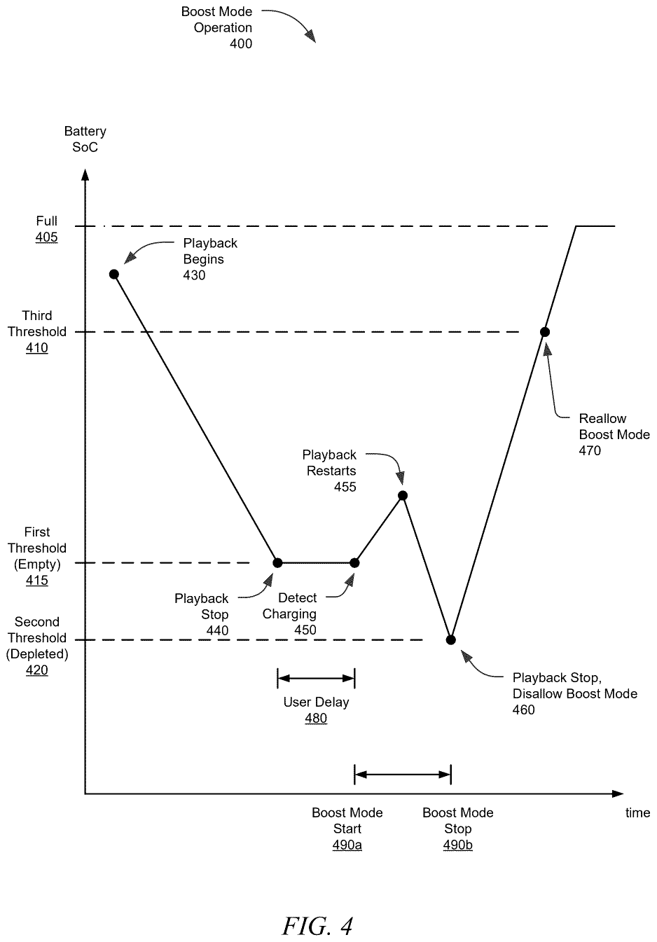

FIG. 4 illustrates boost mode operation 400 of a playback device as a function of battery state of charge over time. As shown, the vertical axis indicates battery state of charge, and the horizontal axis indicates time. The user can initiate audio playback, at 430, on the device at any time when the battery state of charge is between full 405 and empty (first threshold) 415. As playback continues, the state of charge decreases over time as shown. Eventually the charge state reaches the first threshold value 415 (empty) at which point playback may be stopped, at 440. The user may then decide to user initiate charging of the device, for example by plugging the charger port into a power source. If charging is detected, at 450, within a selected time period after the charge state reaches empty, user delay 480, then boost mode operation is started at 490a.

During boost mode operation, the charge state increases until playback restarts at 455. Once play back restarts, the charge state goes back into decline, as shown, although the rate of decline may be slower due to the additional energy being provided by the charging circuit. Eventually, the charge state reaches the second threshold value 420 at which point the battery is completely depleted and the device can no longer continue to operate. Boost mode operation is stopped 490b and the device is powered down. To reduce the possibility of battery damage, future operation in boost mode is disallowed 460. The charging circuit is now able to increase the battery state of charge, as shown. If the playback device is allowed to continue charging, the state of charge will reach a third threshold value 410 at which point future boost mode operation is reallowed 470. Eventually, the state of charge will reach the full state 405 and charging can stop.

In some embodiments, boost mode operation may be activated if the user initiates charging of the device just prior to reaching the empty charge state 415. For example, rather than waiting for playback to stop, the user may observe that the fuel gauge 310 or the remaining playtime gauge 320 indicate that audio playback is about to stop, and so the user preemptively plugs the charger port 240 into a power source.

In some embodiments, the first threshold value 415 is in a range of 2 percent to 10 percent of a fully charged battery state and the second threshold value 420 is in a range of 0 percent to 5 percent of the fully charged battery state. In some embodiments, the third threshold value 410 is in a range of 20 percent to 85 percent of a fully charged battery. In some embodiments, the selected time period 480 is less than 300 seconds.

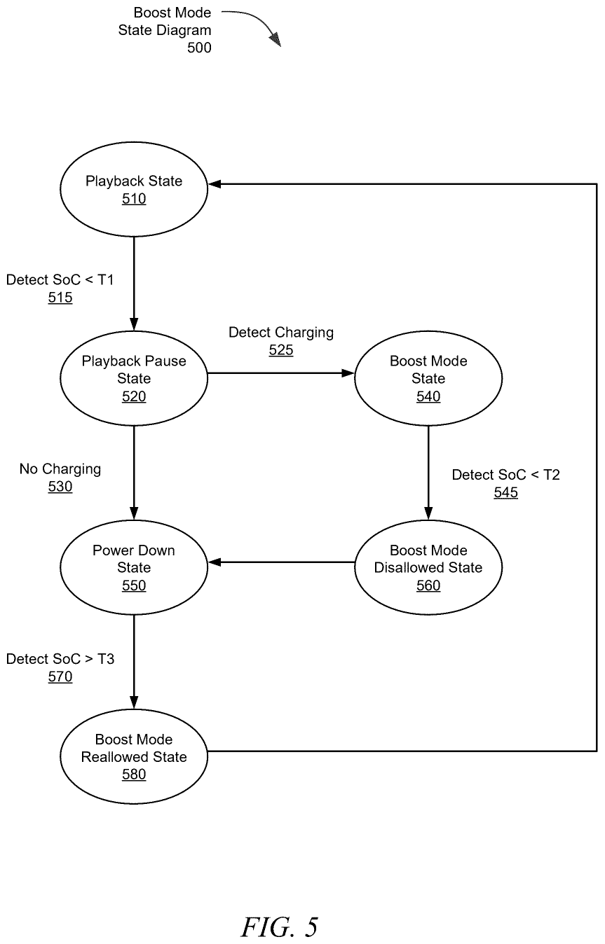

FIG. 5 is a boost mode state diagram 500 of a playback device. The playback device normally operates in a playback state 510. A state transition 515 occurs when the battery state of charge is detected to fall below the first threshold value 415 (empty). The device then enters a playback pause state 520. If charging is not detected within a selected time period, the device transitions, at 530, to a power down state 550. However, if charging is detected, the device transitions, at 525, to a boost mode operation state 540.

From boost mode state 540, another state transition 545 occurs when the battery state of charge is detected to fall below the second threshold value 429 (depleted). The device then enters a boost mode disallowed state 560 to prevent subsequent premature activation of boost mode (e.g., until the battery is restored to a relatively full charge). From state 560, the device transitions to the power down state 550, during which the device may continue to charge.

From power down state 550, a state transition 570 occurs when the battery state of charge is detected to rise back up above a third threshold value 410 at which the battery has been restored to a relatively full charge. The device then enters a boost mode reallowed state 580 in which future boost mode operation is permitted under the circumstances previously described. The device then transitions back to the playback state 510.

### V. Example Methods

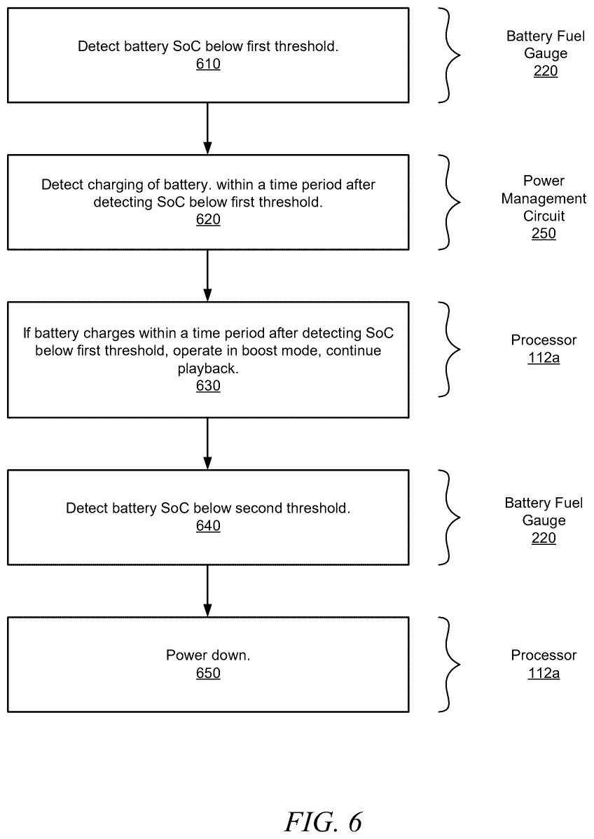

FIG. 6 shows an example embodiment of a method 600 for a playback device to implement boost mode operation, in accordance with aspects of the disclosed technology. As discussed above, the ability to extend play time provided by boost mode operation can provide a meaningful improvement to the user experience by providing an energy reserve when it is most needed. Method 600 can be implemented by a playback device (e.g., device 110) disclosed herein, that is configured for battery powered operation, such as a wireless portable playback device.

Method 600 begins at block 610, which includes detecting that the battery state of charge has fallen below a first threshold value. The first threshold value is associated with an empty state at which the device would ordinarily cease playback and/or shut down. In some embodiments, the battery state of charge may be determined by a battery fuel gauge 220.

At block 620, method 600 further includes detecting that the battery has begun to charge, for example because the user has connected the charger port 240 of the playback device to an external power source.

At block 630, method 600 further includes operating the playback device in battery boost mode if the initiation of battery charging occurs within a pre-determined time period after detecting that the state of charge fell below the first threshold value. In some embodiments, boost mode may also be activated if the battery charging occurs within a pre-determined time period before detecting that the state of charge fell below the first threshold value. Operating the playback device in boost mode includes maintaining the playback device in a powered on state and continuing to play back audio content.

At block 640, method 600 further includes, while operating in boost mode, detecting that the battery state of charge has fallen below a second threshold value. The second threshold value is associated with state at which the battery is depleted to a point that operation is no longer possible (e.g., the reserve capacity has been exhausted).

At block 650, method 600 further includes, while operating in boost mode, ceasing audio playback and powering down the playback device after detecting that the battery state of charge has fallen below the second threshold value.

In some embodiments, the method 600 further includes, after detecting that the charge state has decreased below the second threshold value, disabling subsequent operation of the playback device in boost mode until the battery has been recharged sufficiently to achieve a battery charge state that exceeds a third threshold value.

In some embodiments, the method 600 further includes, displaying the charge state of the battery through a user interface of the playback device and/or providing, through the user interface, an indication of remaining time of operation of the playback device based on the charge state of the battery relative to the first threshold value.

It should be appreciated that various alterations may be made to method 600 without departing from the scope of the present disclosure. For example, one or more blocks and/or steps in method 600 may be removed, reordered, and/or repeated. Accordingly, the method 600 may be altered in any of a variety of ways.

### VI. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### VII. Example Features

(Feature 1) A playback device comprising: a charging circuit configured to charge a battery, the battery configured to provide power for operation of the playback device; a power monitor configured to monitor a charge state of the battery; at least one audio amplifier; at least one processor; at least one non-transitory computer-readable medium comprising program instructions that are executable by the at least one processor such that the playback device is configured to: operate the playback device in a first mode, operation of the playback device in the first mode comprising: playing back audio content using the at least one audio amplifier, detecting that the charge state has decreased below a first threshold value, and ceasing any playback of audio content based on the detected charge state of the battery decreasing below the first threshold value; detect that the playback device is charging the battery; after detecting that the charge state has decreased below the first threshold value and that the playback device is charging the battery, operate the playback device in a second mode, operation of the playback device in the second mode comprising: playing back audio content using the at least one audio amplifier; detecting that the charge state has decreased below a second threshold value, the second threshold value being lower than the first threshold value; and ceasing any playback of audio content based on the detected charge state of the battery decreasing below the second threshold value.

(Feature 2) The playback device of feature 1, wherein the first threshold value is in a range of 2 percent to 10 percent of a fully charged battery state and the second threshold value is in a range of 0 percent to 5 percent of the fully charged battery state.

(Feature 3) The playback device of feature 1, wherein the at least one non-transitory computer-readable medium further comprises program instructions that are executable by the at least one processor such that the playback device is configured to: after detecting that the charge state has decreased below the second threshold value, disable subsequent operation of the playback device in the second mode.

(Feature 4) The playback device of feature 3, wherein the at least one non-transitory computer-readable medium further comprises program instructions that are executable by the at least one processor such that the playback device is configured to: after disabling further operation of the playback device in the second mode, detect that the charge state has increased above a third threshold value, the third threshold value greater than or equal to the first threshold value; and after detecting that the charge state has increased above the third threshold value, re-enable subsequent operation of the playback device in the second mode.

(Feature 5) The playback device of feature 4, wherein the third threshold value is in a range of 20 percent to 85 percent of a fully charged battery.

(Feature 6) The playback device of feature 1, wherein the charging circuit is configured to detect a connection between the playback device and an external power source and to detect that the playback device is charging the battery in response to detection of the connection.

(Feature 7) The playback device of feature 6, wherein the charging circuit is configured to detect a break in the connection and to detect that the playback device is not charging the battery in response to detection of the break.

(Feature 8) The playback device of feature 1, wherein the playback device further comprises a voltage regulation circuit configured to provide power to the playback device at a regulated voltage level as the charge state of the battery varies between a fully charged battery state and the second threshold value.

(Feature 9) The playback device of feature 1, wherein the playback device further comprises a user interface.

(Feature 10) The playback device of feature 9, wherein the at least one non-transitory computer-readable medium further comprises program instructions that are executable by the at least one processor such that the playback device is configured to display, through the user interface, the charge state of the battery.

(Feature 11) The playback device of feature 9, wherein the at least one non-transitory computer-readable medium further comprises program instructions that are executable by the at least one processor such that the playback device is configured to provide, through the user interface, an indication of remaining time of operation of the playback device based on the charge state of the battery relative to the first threshold value.

(Feature 12) The playback device of feature 9, wherein the at least one non-transitory computer-readable medium further comprises program instructions that are executable by the at least one processor such that the playback device is configured to provide, through the user interface, an indication that the charge state has decreased below the first threshold value.

(Feature 13) The playback device of feature 1, wherein the second threshold value is associated with a minimum charge state at which the playback device can play back audio content using the at least one audio amplifier.

(Feature 14) The playback device of feature 1, wherein the at least one non-transitory computer-readable medium further comprises program instructions that are executable by the at least one processor such that the playback device is configured to operate the playback device in the second mode after detecting that the playback device is charging the battery within a selected time period after detecting that the charge state has decreased below the first threshold value.

(Feature 15) The playback device of feature 14, wherein the selected time period is less than 300 seconds.

(Feature 16) A method of determining user intent to continue playback operation of a playback device, the method comprising: detecting that a charge state of a battery of the playback device has decreased below a first threshold value; detecting a connection between the playback device and an external power source within a selected time period after determining that the charge state has decreased below the first threshold value; after the detection, operating the playback device in a boost mode, the boost mode comprising: maintaining the playback device in a powered on state wherein the playback device plays back one or more channels of audio content; detecting that the charge state has decreased below a second threshold value, the second threshold value lower than the first threshold value; and after detecting that the charge state has decreased below the second threshold value, powering down the playback device.

(Feature 17) A method of determining user intent to continue playback operation of a playback device, the method comprising: operating the playback device in a first mode, operation of the playback device in the first mode comprising: playing back audio content using at least one audio amplifier of the playback device, detecting that a charge state of a battery of the playback device has decreased below a first threshold value, and ceasing any playback of audio content based on the detected charge state of the battery decreasing below the first threshold value; detecting that the playback device is charging the battery; after detecting that the charge state has decreased below the first threshold value and that the playback device is charging the battery, operate the playback device in a second mode, operation of the playback device in the second mode comprising: playing back audio content using the at least one audio amplifier; detecting that the charge state has decreased below a second threshold value, the second threshold value being lower than the first threshold value; and ceasing any playback of audio content based on the detected charge state of the battery decreasing below the second threshold value.

(Feature 18) The method of feature 17, wherein a connection of the playback device to an external power source enables charging of the battery.

(Feature 19) The method of feature 17, wherein the first threshold value is in a range of 2 percent to 10 percent of a fully charged battery state and the second threshold value is in a range of 0 percent to 5 percent of the fully charged battery state.

(Feature 20) The method of feature 17, wherein the selected time period is less than 300 seconds.

(Feature 21) The method of feature 17, further comprising, after detecting that the charge state has decreased below the second threshold value, disabling subsequent operation of the playback device in the second mode.

(Feature 22) The method of feature 21, further comprising: after disabling further operation of the playback device in the second mode, detecting that the charge state has increased above a third threshold value, the third threshold value greater than or equal to the first threshold value; and after detecting that the charge state has increased above the third threshold value, re-enabling subsequent operation of the playback device in the second mode.

(Feature 23) The method of feature 22, wherein the third threshold value is in a range of 20 percent to 85 percent of a fully charged battery.

(Feature 24) The method of feature 17, further comprising displaying the charge state of the battery through a user interface of the playback device.

(Feature 25) The method of feature 17, further comprising providing, through a user interface of the playback device, an indication of remaining time of operation of the playback device based on the charge state of the battery relative to the first threshold value.

(Feature 26) The method of feature 17, further comprising providing, through a user interface of the playback device, an indication that the charge state has decreased below the first threshold value.

(Feature 27) The method of feature 17, wherein the second threshold value is associated with a minimum charge state at which the playback device can play back audio content using the at least one audio amplifier.

(Feature 28) A method for a playback device comprising a battery configured to provide power for operation of the playback device, the method comprising: while playing back audio content via at least one audio amplifier, causing the playback of the audio content to cease when a charge state of the battery is below a first threshold value; and after causing the playback of the audio content to cease and based on detecting that the battery is being charged while the battery charge state is below the first threshold value, allowing the playback device to play back audio content via the at least one amplifier unless the charge state of the battery is lower than a second threshold value, the second threshold value lower than the first threshold value.

(Feature 29) The method of feature 28, wherein the first threshold value is in a range of 2 percent to 10 percent of a fully charged battery state and the second threshold value is in a range of 0 percent to 5 percent of the fully charged battery state.

(Feature 30) The method of feature 28 or 29, wherein allowing the playback device to play back audio content via the at least one amplifier unless the charge state of the battery is lower than a second threshold value comprises: based on detecting that the charge state has decreased below the second threshold value, disabling subsequent operation of the playback device.

(Feature 31) The method of feature 30, further comprising: after disabling further operation of the playback device based on detecting that the charge state has decreased below the second threshold value, re-enabling subsequent operation of the playback device in the second mode after detecting that the charge state has increased above a third threshold value, the third threshold value greater than or equal to the first threshold value.

(Feature 32) The method of feature 31, wherein the third threshold value is in a range of 20 percent to 85 percent of a fully charged battery.

(Feature 33) The method of any preceding feature, wherein the playback device comprises a charging circuit configured to detect a connection between the playback device and an external power source, wherein detecting that the battery is being charged comprises detecting the connection.

(Feature 34) The method of feature 33, wherein the charging circuit is configured to detect a break in the connection and to detect that the playback device is not charging the battery in response to detection of the break.

(Feature 35) The method of any preceding feature, wherein the playback device further comprises a voltage regulation circuit configured to provide power to the playback device at a regulated voltage level as the charge state of the battery varies between a fully charged battery state and the second threshold value.

(Feature 36) The method of any preceding feature, wherein the playback device further comprises a user interface configured to display at least one of: a charge state of the battery; an indication of remaining time of operation of the playback device based on the charge state of the battery relative to the first threshold value; and an indication that the charge state has decreased below the first threshold value.

(Feature 37) The method of any preceding feature, wherein the second threshold value is associated with a minimum charge state at which the playback device can play back audio content using the at least one audio amplifier.

(Feature 38) The method of any preceding feature, wherein detecting that the battery is being charged and while the battery charge state is below the first threshold value comprises detecting that the playback device is charging the battery within a selected time period after detecting that the charge state has decreased below the first threshold value.

(Feature 39) The method of feature 38, wherein the selected time period is less than 300 seconds.

(Feature 40) The method of any preceding feature, wherein detecting that the battery is being charged comprises detecting a connection between the playback device and an external power source.

(Feature 41) The method of any preceding feature, wherein the second threshold value is associated with a minimum charge state at which the playback device can play back audio content using the at least one audio amplifier.

(Feature 42) A playback device comprising a battery, at least one amplifier, and a processor configured to perform the method of any preceding feature.

1-27. (canceled)

28. A playback device comprising:
a charging circuit configured to charge a battery, the battery configured to provide power for operation of the playback device;
a power monitor configured to monitor a charge state of the battery;
at least one audio amplifier;
at least one processor;
at least one non-transitory computer-readable medium comprising program instructions that are executable by the at least one processor such that the playback device is configured to:
operate the playback device in a first mode, operation of the playback device in the first mode comprising:
playing back audio content using the at least one audio amplifier,
detecting that the charge state has decreased below a first threshold value, and
ceasing any playback of audio content based on the detected charge state of the battery decreasing below the first threshold value;
detect that the playback device is charging the battery;
after detecting that the charge state has decreased below the first threshold value and that the playback device is charging the battery, operate the playback device in a second mode, operation of the playback device in the second mode comprising:
playing back audio content using the at least one audio amplifier;
detecting that the charge state has decreased below a second threshold value, the second threshold value being lower than the first threshold value; and
ceasing any playback of audio content based on the detected charge state of the battery decreasing below the second threshold value.

29. The playback device of claim 28, wherein the first threshold value is in a range of 2 percent to 10 percent of a fully charged battery state and the second threshold value is in a range of 0 percent to 5 percent of the fully charged battery state.

30. The playback device of claim 28, wherein the at least one non-transitory computer-readable medium further comprises program instructions that are executable by the at least one processor such that the playback device is configured to:
after detecting that the charge state has decreased below the second threshold value, disable subsequent operation of the playback device in the second mode.

31. The playback device of claim 30, wherein the at least one non-transitory computer-readable medium further comprises program instructions that are executable by the at least one processor such that the playback device is configured to:
after disabling further operation of the playback device in the second mode, detect that the charge state has increased above a third threshold value, the third threshold value greater than or equal to the first threshold value; and
after detecting that the charge state has increased above the third threshold value, re-enable subsequent operation of the playback device in the second mode.

32. The playback device of claim 31, wherein the third threshold value is in a range of 20 percent to 85 percent of a fully charged battery.

33. The playback device of claim 28, wherein the charging circuit is configured to detect a connection between the playback device and an external power source and to detect that the playback device is charging the battery in response to detection of the connection; and the charging circuit is configured to detect a break in the connection and to detect that the playback device is not charging the battery in response to detection of the break.

34. The playback device of claim 28, wherein the playback device further comprises a voltage regulation circuit configured to provide power to the playback device at a regulated voltage level as the charge state of the battery varies between a fully charged battery state and the second threshold value.

35. The playback device of claim 28, wherein the playback device further comprises a user interface.

36. The playback device of claim 35, wherein the at least one non-transitory computer-readable medium further comprises program instructions that are executable by the at least one processor such that the playback device is configured to:
display, through the user interface, the charge state of the battery;
provide, through the user interface, an indication of remaining time of operation of the playback device based on the charge state of the battery relative to the first threshold value; and
provide, through the user interface, an indication that the charge state has decreased below the first threshold value.

37. The playback device of claim 28, wherein the second threshold value is associated with a minimum charge state at which the playback device can play back audio content using the at least one audio amplifier.

38. The playback device of claim 28, wherein the at least one non-transitory computer-readable medium further comprises program instructions that are executable by the at least one processor such that the playback device is configured to operate the playback device in the second mode after detecting that the playback device is charging the battery within a selected time period after detecting that the charge state has decreased below the first threshold value.

39. The playback device of claim 38, wherein the selected time period is less than 300 seconds.

40. A method of determining user intent to continue playback operation of a playback device, the method comprising:
detecting that a charge state of a battery of the playback device has decreased below a first threshold value;
detecting a connection between the playback device and an external power source within a selected time period after determining that the charge state has decreased below the first threshold value;
after the detection, operating the playback device in a boost mode, the boost mode comprising:
maintaining the playback device in a powered on state wherein the playback device plays back one or more channels of audio content;
detecting that the charge state has decreased below a second threshold value, the second threshold value lower than the first threshold value; and
after detecting that the charge state has decreased below the second threshold value, powering down the playback device.

41. A method of determining user intent to continue playback operation of a playback device, the method comprising:
operating the playback device in a first mode, operation of the playback device in the first mode comprising:
playing back audio content using at least one audio amplifier of the playback device,
detecting that a charge state of a battery of the playback device has decreased below a first threshold value, and
ceasing any playback of audio content based on the detected charge state of the battery decreasing below the first threshold value;
detecting that the playback device is charging the battery;
after detecting that the charge state has decreased below the first threshold value and that the playback device is charging the battery, operate the playback device in a second mode, operation of the playback device in the second mode comprising:
playing back audio content using the at least one audio amplifier;
detecting that the charge state has decreased below a second threshold value, the second threshold value being lower than the first threshold value; and
ceasing any playback of audio content based on the detected charge state of the battery decreasing below the second threshold value.

42. The method of claim 41, wherein a connection of the playback device to an external power source enables charging of the battery.

43. The method of claim 41, wherein the first threshold value is in a range of 2 percent to 10 percent of a fully charged battery state, and the second threshold value is in a range of 0 percent to 5 percent of the fully charged battery state.

44. The method of claim 41, wherein the second threshold value is associated with a minimum charge state at which the playback device can play back audio content using the at least one audio amplifier.

45. The method of claim 41, further comprising, after detecting that the charge state has decreased below the second threshold value, disabling subsequent operation of the playback device in the second mode.

46. The method of claim 45, further comprising:
after disabling further operation of the playback device in the second mode, detecting that the charge state has increased above a third threshold value, the third threshold value greater than or equal to the first threshold value, wherein the third threshold value is in a range of 20 percent to 85 percent of a fully charged battery; and
after detecting that the charge state has increased above the third threshold value, re-enabling subsequent operation of the playback device in the second mode.

47. The method of claim 41, further comprising:
displaying the charge state of the battery through a user interface of the playback device;
providing, through the user interface of the playback device, an indication of remaining time of operation of the playback device based on the charge state of the battery relative to the first threshold value; and
providing, through the user interface of the playback device, an indication that the charge state has decreased below the first threshold value.
